(19) United States
(12) Patent Application Publication
(10) Pub. No.: US 2016/0295818 A1
(43) Pub. Date: Oct. 13, 2016

(54) Collapsible Liquid Container and Dispenser

(71) Applicants: Wei Young, Flushing, NY (US); Christine L. Reibl, West Chester, PA (US); William P. Reibl, West Chester, PA (US)

(72) Inventors: Wei Young, Flushing, NY (US); Christine L. Reibl, West Chester, PA (US); William P. Reibl, West Chester, PA (US)

(73) Assignee: INFUSION LIVING LLC, West Chester, PA (US)

(21) Appl. No.: 14/680,412

(22) Filed: Apr. 7, 2015

(51) Int. Cl. A01G 25/14; B65D 25/48; B65D 21/08

(52) U.S. Cl. CPC A01G 25/14; B65D 21/086; B65D 25/48

(57) ABSTRACT

Apparatus and methods are described for the containment and dispensing of liquid in a container that can be stored more conveniently and easily. Apparatus are described wherein the liquid containing and dispensing apparatus has a main body and collapsible sides that enclose a liquid holding reservoir which is in fluid communication with a collapsible spout. The collapsibility of the sides and the spout reduces the size of both the profile and the volume of the apparatus, allowing it to be more easily stored.

### FIELD OF THE DISCLOSURE

Aspects of the present disclosure relate to apparatus for containing and dispensing liquids.

### BACKGROUND

Various devices and methods exist for containment and delivery of liquids. Common liquid containers that can both contain and deliver liquids include gasoline cans, oil cans, and watering cans. Often, such containers have bodies capable of receiving and holding liquids and elongated spouts in fluid communication with the bodies. It has been recognized that the shape of such containers can make storage difficult. Solutions to this difficulty have previously focused on the protruding elongated spouts which are often included on such containers, and various means have been taught for making spouts easier to store.

### SUMMARY

The present disclosure recognizes the need to address storage problems caused, not only by the spouts of liquid containing and dispensing apparatus, but also by the main body of liquid containing and dispensing apparatus.

One objective of some embodiments of the present disclosure is to provide apparatus and methods for containment and delivery of liquids in a container that can be stored more easily than prior containers, without reducing the capacity of the liquid containing and dispensing apparatus to hold liquid or interfering with the ease and comfort of the user in containing and/or dispensing liquid.

Apparatus and methods are described for the containment and dispensing of liquid in a container that can be stored more conveniently and easily. Apparatus are described wherein a liquid containing and dispensing apparatus has a main body and collapsible sides that enclose a liquid holding reservoir which is in fluid communication with a collapsible spout. The collapsibility of the sides and the spout reduces the size of both the profile and the volume of the apparatus, allowing it to be more easily stored.

One or more alternate or additional objectives may be served by the present disclosure, e.g., as may be apparent by the following description. Embodiments of the disclosure include any apparatus, machine, system, method, articles, or any one or more subparts or subcombinations of such apparatus (singular or plural), system, method, or article, e.g., as supported by the present disclosure.

### BRIEF DESCRIPTION OF THE DRAWINGS

Example embodiments will be described with reference to the following figures in which:

FIG. 1 is a schematic diagram showing a right-side profile view of a liquid containing and dispensing apparatus with a spout extended and sides expanded according to one embodiment.

FIG. 2 is a schematic diagram showing an exploded view of a liquid containing and delivering apparatus according to one embodiment.

FIG. 3 is a schematic diagram showing a front view of a liquid containing and dispensing apparatus with a spout extended and sides expanded according to one embodiment.

FIG. 4 is a schematic diagram showing a rear view of a liquid containing and dispensing apparatus with sides expanded according to one embodiment.

FIG. 5 is a schematic diagram showing a perspective view of a liquid containing and dispensing apparatus with a spout extended and sides expanded according to one embodiment.

FIG. 6 is a schematic diagram showing a bottom view of a liquid containing and dispensing apparatus with a spout extended and sides expanded according to one embodiment.

FIG. 7 is a schematic diagram showing a left-side profile view of a liquid containing and dispensing apparatus with a spout extended and sides collapsed according to one embodiment.

FIG. 8 is a schematic diagram showing a left-side view of a liquid containing and dispensing apparatus with a spout collapsed and sides collapsed according to one embodiment.

FIG. 9 is a schematic diagram showing a left-side view of a liquid containing and dispensing apparatus with a spout folded up and sides collapsed according to one embodiment.

### DETAILED DESCRIPTION

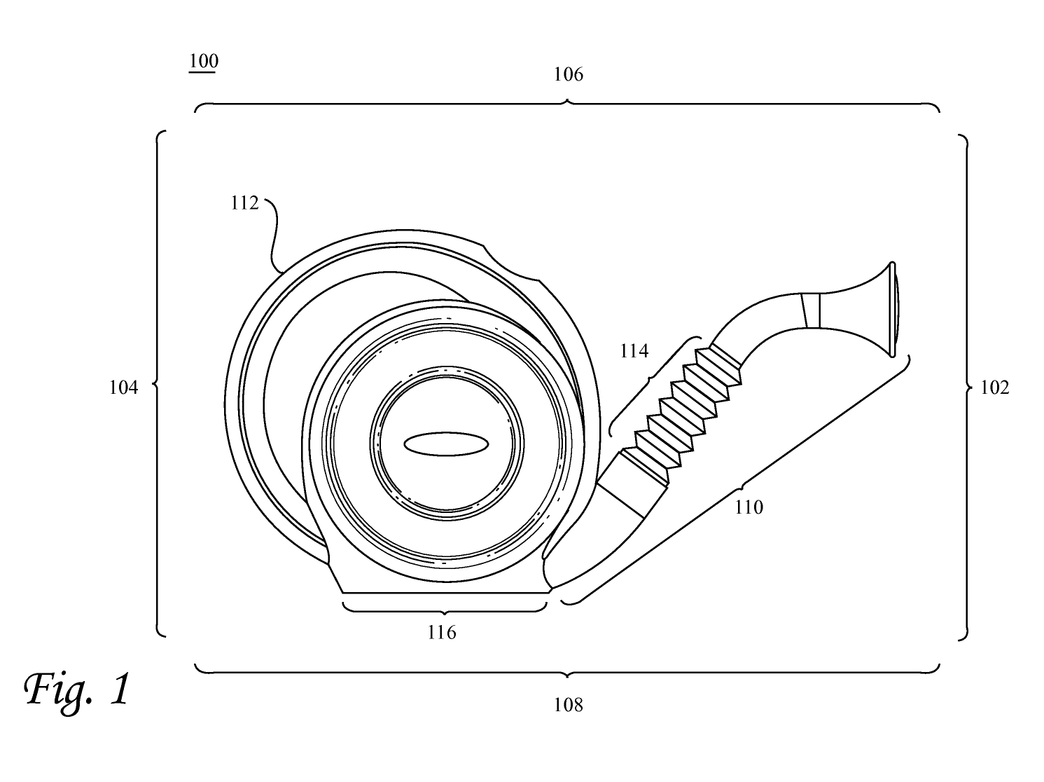

Referring now the drawings in greater detail, FIG. 1 presents a schematic diagram showing a right-side profile view of a liquid containing and dispensing apparatus 100 with a spout 110 extended and sides 302 expanded according to one embodiment. The apparatus according to one embodiment comprises a front facing side 102, a rear facing side 104, a top facing side 106, and a bottom facing side 108. In embodiments such as the one depicted in FIG. 1, a front facing side 102 has a spout 110.

The area enclosed within a front facing side 102, a rear facing side 104, a top facing side 106, and a bottom facing side 108, and sides 302 is a liquid holding reservoir 116 capable of containing liquid. The liquid holding reservoir 116 is in fluid communication with a spout 110, thus allowing the apparatus 100 to dispense any liquid contained in a liquid holding reservoir 116 through a spout 110. In embodiments, a spout 110 is in fluid communication with a liquid holding reservoir 116 through a spout attaching chamber 206.

A spout 110 may, according to embodiments, comprise accordion piping 114. Such accordion piping 114 allows a spout 110 to be extended (as depicted), folded, or collapsed.

A gripping member 112 may comprise an upper end extending from the top of a front facing side 102 to the bottom of a rear facing side 104. A gripping member 112 may be rounded or otherwise ergonomically shaped to allow for the comfortable gripping, holding, carrying, raising, lowering, and tipping of the liquid containing and dispensing apparatus 100. A bottom facing side 108 may, according to one embodiment, comprise a base 601 that is flat and of sufficient area to allow the liquid containing and dispensing apparatus 100 to rest stably and without tipping on a flat, nearly flat, or mostly flat surface when empty or when partially or completely filled with liquid. A gripping member 112 may be solid or it may be hollow, in whole or in part. A wholly or partially hollow gripping member 112 may be in fluid communication with a liquid holding reservoir 116.

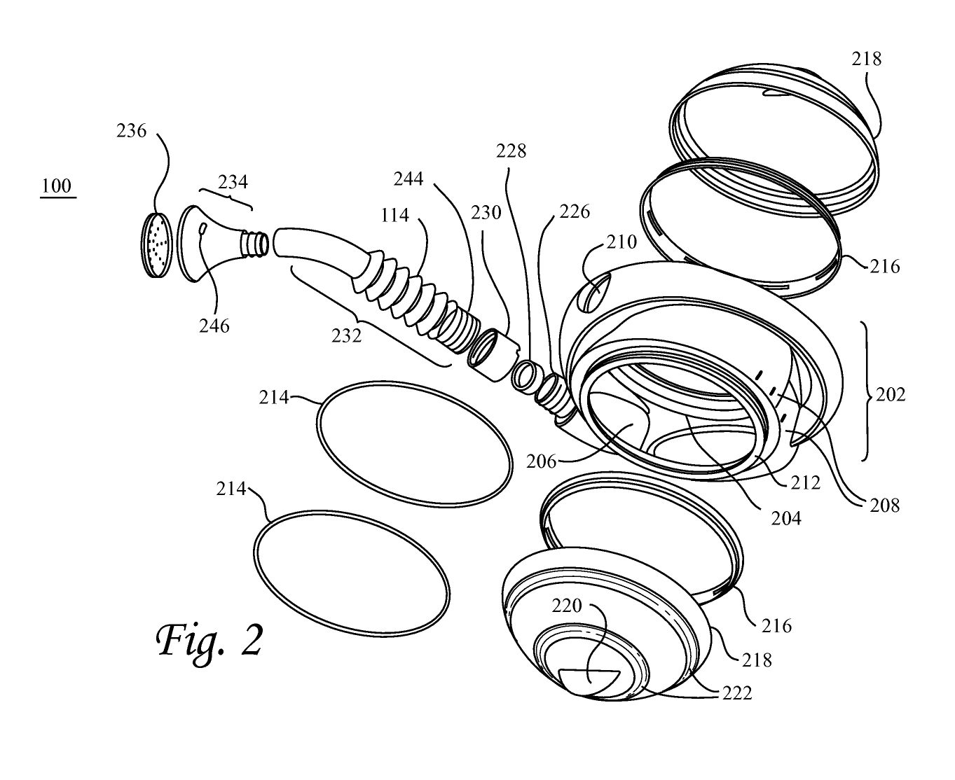

FIG. 2 presents a schematic diagram showing an exploded view of a liquid containing and dispensing apparatus 100 according to one embodiment. A main body 202, according to embodiments, may be made of any rigid material including hard plastic such as, in embodiments, blow-molded plastic, injected molded plastic, or metal. A main body 202 according to embodiments may be made in one piece or in plural pieces. The plural pieces may, for example, in embodiments be made of injection molded plastic. The plural pieces can then be assembled by fusing or bonding the pieces together or by any other practicable means.

A front facing side 102, a rear facing side 104, a top facing side 106, and a bottom facing side 108 together form a chamber 204 with a left side opening on the left side of a main body 202 and a right side opening on the right side of a main body 202. With sides 302 attached to a main body 202, a left side opening and a right side opening will be closed and a chamber 204 will be the interior of a liquid holding reservoir 116.

A main body 202 may, according to embodiments, comprise a gripping member 112. In embodiments, a fill opening 210 through which liquids may be poured into the liquid holding reservoir 116 may be placed on a main body 202, and may, in embodiments be placed on a gripping member 112. In embodiments, a fill opening 210 may have a removable cap while in other embodiments it may remain open.

In embodiments, a main body may further comprise indicator lines 208 placed to indicate the volume of liquid within a liquid holding reservoir 116 or otherwise contained in the apparatus 100. Indicator lines 208 may, in embodiments, be provided in one set or in plural sets to indicate the volume of liquid with both sides 302 expanded or with one or more sides 302 partially or fully collapsed.

A main body 202 may further comprise a spout attaching chamber 206 which is open to and in fluid communication with a liquid holding reservoir 116 and which comprises a spout receiver 226. A spout receiver 226, in embodiments, may be a threaded male screw for attaching to a threaded female end of a spout 110 or a coupling ring 230. In other embodiments the male/female threading orientations may be reversed. In other embodiments a spout 110 and a liquid containing reservoir 116 may be in direct fluid communication and a spout 110 and a main body 202 may be attached by means other than a male-female screw attachment, such as with adhesive.

The main body 202 may further comprise ridge rings 212 that may be raised around a left side opening and a right side opening. Ridge rings 212 may be threaded in a male or female orientation to attach to a side 302, or may attach to a side 302 through other means such as adhesive.

Sides 302 may comprise a gasket 214 a coupling ring 216 and a drum 218.

A drum 218 may be made of any material that is flexible and capable of collapsing, or holding plural positions, including rubber, plastic, polymers such as thermoplastic elastomers including various Kraton® thermoplastic elastomer products, specifically including Kraton® DynaFlex™ and VersaFlex™ products. The material may be opaque, transparent, semitransparent, translucent, or semi-translucent, and may be colorable. A drum 218 may have fold lines 222 such as rings where the material is thinner to facilitate collapsing and expanding of sides 302. A drum 218 could be made of an alternative material, including a hard material, if the fold lines 222 facilitate the collapsing and expanding of sides 302. A drum 218 may further comprise handles 220 to facilitate quick and easy expansion and collapse of sides 302 by a user without any screws, springs, hinges, lugs, chains, struts or other mechanical manipulations beyond simply pulling or pushing on the sides 302, for example by using the handles 220.

A coupling ring 216 may be made of a hard material such as a hard plastic, including a blow-molded plastic. Coupling ring 216 may be attached or fused to a drum 218 to form a coupling drum. A coupling ring 216 may have means to attach a drum 218 or a coupling drum to a main body 202 of a liquid containing and dispensing apparatus 100, such as at a ridge ring 212. It may have male or female oriented screw threading to complement the threading of a ridge ring 212 and facilitate attachment of a drum 218 or a coupling drum to a main body 202 of a liquid containing and dispensing apparatus 100.

In alternative embodiments, a drum 218 may be threaded or have other means of attaching directly to a main body 202 of a liquid containing and dispensing apparatus 100, for example with an adhesive, without need for a separate coupling ring 216 or the formation of a drum 218 or coupling drum.

A drum 218 or a coupling drum may attach to a main body 202 of a liquid containing and dispensing apparatus 100 with or without a gasket 214. A side 302 may, as examples of alternative embodiments without limiting thereto, comprise only a drum 218, only a coupling drum, or either a drum 218 or a coupling drum with or without a gasket 214.

A gasket 214 may be either a flat circular ring or may be a torus such as an O-ring. It may also be in any alternative shape that fits between a drum 218 or coupling drum and a main body 202 of a liquid containing and dispensing apparatus 100. A gasket 214 may be made of rubber, including silicone rubber, or any material capable of sealing any gap between a drum 218 or a coupling drum and a main body 202 of a liquid containing and dispensing apparatus 100.

In embodiments, sides 302 may be co-molded with the single main body 202 or, if the main body is made in plural pieces, the sides 302 may be co-molded to the plural pieces before or after the plural pieces are assembled to form the a main body 202. Other means of attaching sides 202 to a main body 202 besides co-molding, such as by screwing or adhesives, may also be used.

Sides 302 and a main body 202 of the liquid containing and dispensing apparatus 100 enclose a liquid holding reservoir 116 which is in fluid communication with a spout 110 either, for example, directly or via a spout attaching chamber 206.

A spout 110 may, in various embodiments, comprise a spout gasket sleeve 228, a spout locking coupler 230, a neck 232, a sprinkler head housing 234, and a sprinkler head 236.

A neck 232 may further comprise a collar 244 and accordion piping 114. The neck may, in certain embodiments, be made of plastic including blow-molded plastic, but it may also be made of other materials or combinations of materials, including metals. A collar 244 may be threaded with male or female oriented screw threading to complement any threading on a spout receiver 226, or it may attach to a spout receiver 226 by other means including through use of an adhesive.

A sprinkler head housing 234 may be made of either a hard material such as plastic including blow-molded plastic, or it may be made of a soft or flexible material such as thermoplastic elastomer or any material from which a drum 218 may be made. It may be attached to a neck 232 and it may be removable from a neck 232 by a user to facilitate dispensing of liquid directly from a neck 232 or to facilitate replacement of a sprinkler head housing 234, or for any other purpose. Sprinkler head housing 234 may be fitted into a fill opening 210 of a main body 202 of a liquid containing and dispensing apparatus 100 to allow a user to place and hold a sprinkler head housing 234 while dispensing liquid directly from a neck 232 or whenever a sprinkler head housing 234 is removed from a neck 232. A sprinkler head housing 234 may have one or plural locking tabs 246. Locking tabs 246 may be shaped and positioned to secure a sprinkler head housing 234 within a fill opening 210 without falling into a liquid holding reservoir 116.

A sprinkler head 236 may fit onto a sprinkler head housing 234 on a spout 110. A sprinkler head 236 may have holes of various sizes and arranged in various positions to control the rate and direction of distribution of liquid dispensed from a liquid containing and dispensing apparatus 100. A sprinkler head 236 may be part of a sprinkler head housing 234 and integrated as one piece therewith, or it may be a separate piece and removable and replaceable apart from a sprinkler head housing 234.

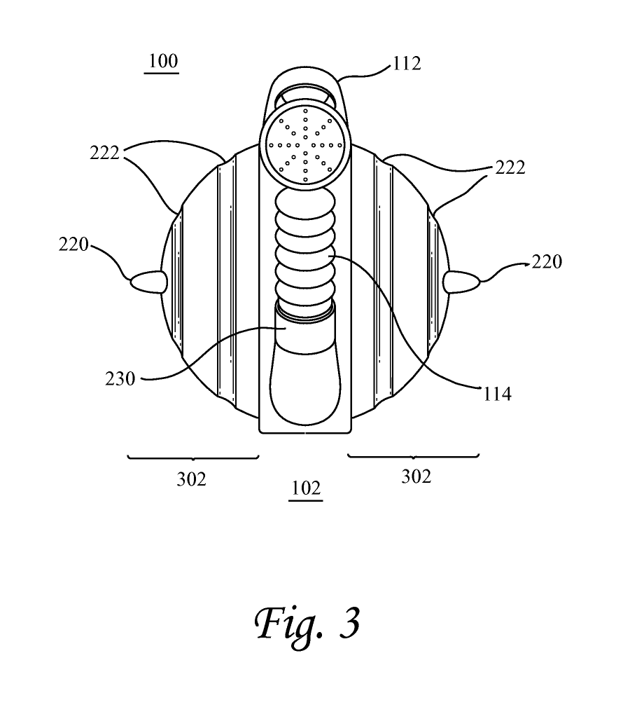

FIG. 3 presents a schematic diagram showing a front facing side 102 of a liquid containing and dispensing apparatus 100 with a spout 110 in a fully extended position and sides 302 expanded according to one embodiment. A spout locking coupler 230 may connect a main body 202 of a liquid containing and dispensing apparatus 100 to a spout 110 by fitting over a spout receiver 226 on a spout attaching chamber 206. A spout locking coupler 230 may secure a spout 110 to a main body 202 by screwing to a spout receiver 226 and a collar 244 of a neck 232 so that the spout locking coupler 230 rests flush against a main body 202. A liquid containing and dispensing apparatus 100 may comprise a gripping member 112. Sides 302 may comprise handles 220 and fold lines 222.

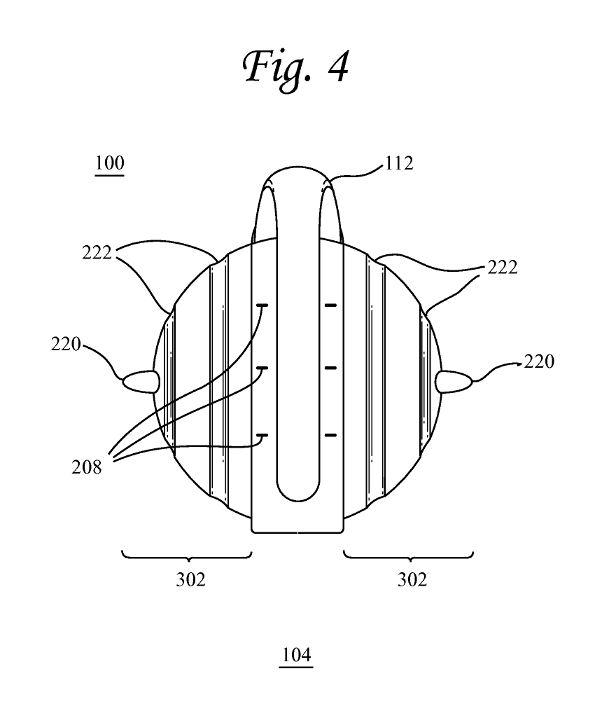

FIG. 4 presents a schematic diagram showing a rear facing side 104 of a liquid containing and dispensing apparatus 100 with sides 302 expanded according to one embodiment. A gripping member 112 may extend to the bottom of a rear facing side 104 of a main body 202 of a liquid containing and dispensing apparatus 100. Sides 302 may comprise handles 220 and fold lines 222. A main body 202 or sides 302 or a spout 110 may comprise indicator lines 208 to indicate the volume of liquid in a liquid holding reservoir 116 of a liquid containing and dispensing apparatus 100. The main body 202, sides 302, or spout 110 where indicator lines may be placed may be transparent, semi-transparent, translucent or semi-translucent to allow a user to see an indication of the top of liquid in a liquid holding reservoir 116 or other portion of a liquid containing and dispensing apparatus 100.

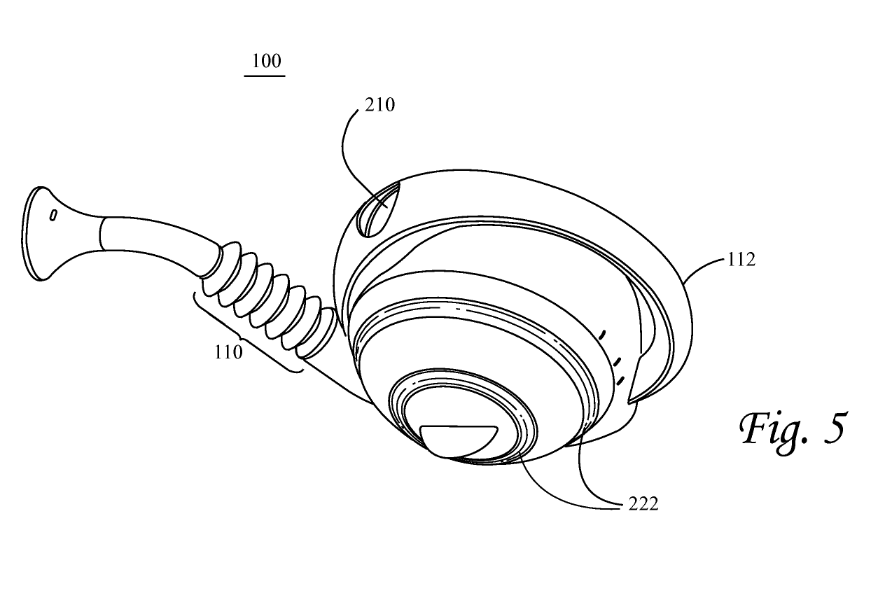

FIG. 5 presents a schematic diagram showing a perspective view of a liquid containing and dispensing apparatus 100 with a spout 110 extended and sides 302 expanded according to one embodiment. A fill opening 210 may be placed on a gripping member 112 or other portion of a main body 202. A side 302 may comprise fold lines 222 to facilitate collapse of sides 302 for easy storage or to decrease the volume of liquid held in a liquid holding reservoir 116. Sides 302 may collapse along one or plural fold lines 222.

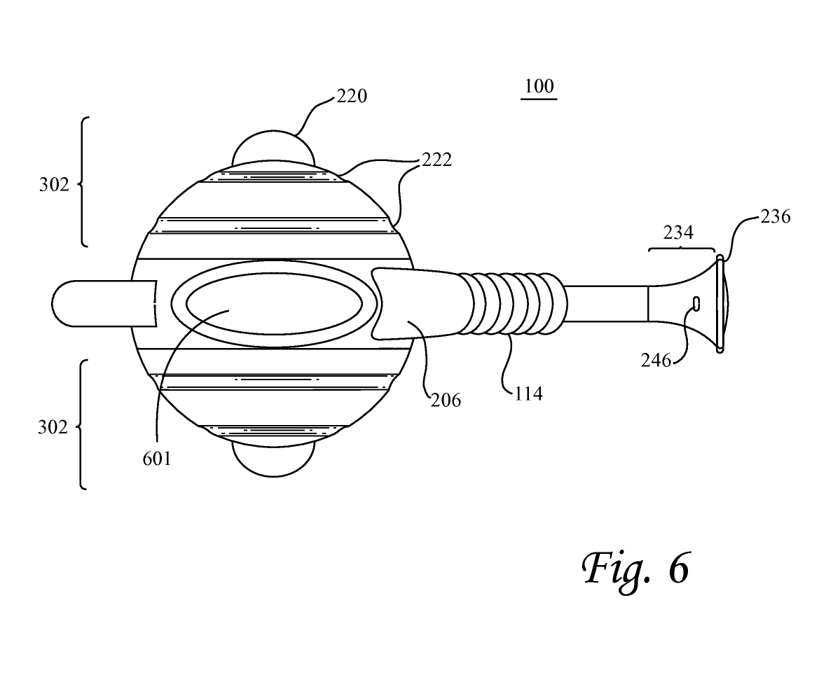

FIG. 6 presents a schematic diagram showing a bottom facing side 108 of a liquid containing and dispensing apparatus 100 with accordion piping 114 of a spout 110 fully extended and sides 302 expanded according to one embodiment. A main body 202 may comprise a spout attaching chamber 206 connected to a spout 110 and in fluid communication with a liquid holding reservoir 116. A base 601 may be flat and of sufficient area to allow the liquid containing and dispensing apparatus 100 to rest stably and without tipping on a flat surface when empty or when a liquid holding reservoir 116 is partially or completely filled with liquid.

FIG. 7 presents a schematic diagram showing a left-side profile view of a liquid containing and dispensing apparatus 100 with accordion piping 114 of a spout 110 fully extended and sides 302 collapsed according to one embodiment.

FIG. 8 presents a schematic diagram showing a left-side view of a liquid containing and dispensing apparatus 100 with accordion piping 114 of a spout fully collapsed and sides 302 fully collapsed according to one embodiment. Sides 302 may be collapsed along fold lines 222.

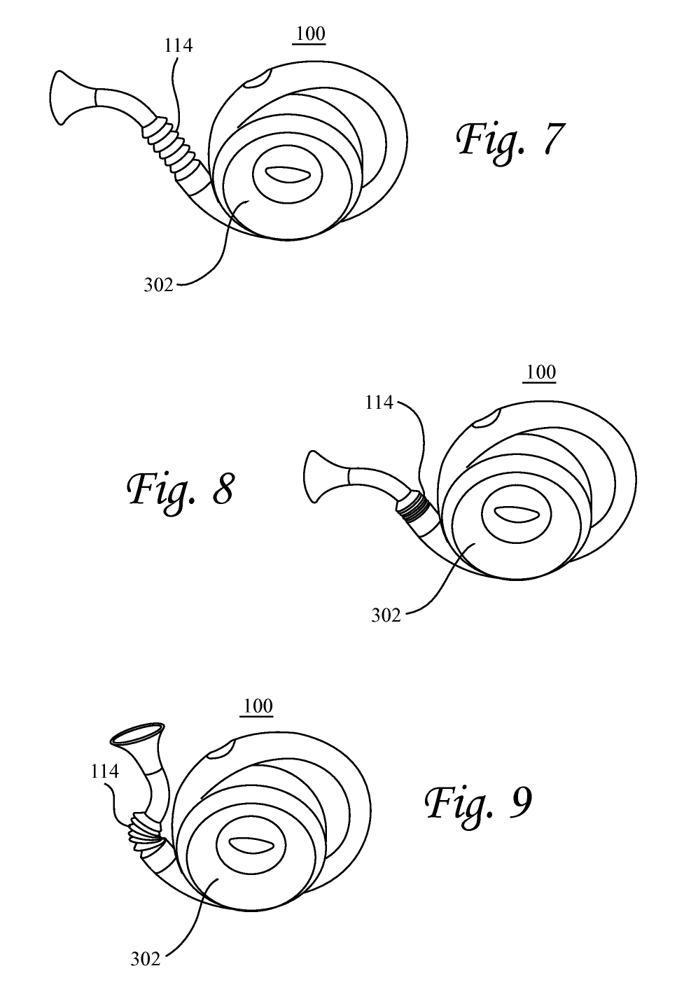

FIG. 9 presents a schematic diagram showing a left-side view of a liquid containing and dispensing apparatus 100 with accordion piping 114 of a spout 110 folded up and sides 302 fully collapsed along fold lines 222 according to one embodiment. In embodiments, a spout 110 may be folded up, down, or in any direction 360° around an imaginary axis through the center of a spout 110. A user may compress or fold accordion piping 114 of a spout 110 to position the spout for ease or comfort when dispensing liquid or for convenient storage, or for any other reason.

In alternative embodiments, an entire liquid containing and dispensing apparatus 100 may be manufactured in one piece with a main body 202, a spout, 110, and sides 302 as one unit of the same material wherein sides 302 are flexible and collapsible. In other alternative embodiments a main body 202 and a spout 110 may be one contiguous unit of the same material with flexible sides 302 attached. In still other alternatives, a main body 202 and sides 302 may be one unit of the same material while a spout 110 is attached separately. The liquid containing and dispensing apparatus need only have a main body 202 and flexible sides 302 that enclose a liquid holding reservoir 116 in fluid communication with a spout 110 whether a main body 202, sides 302, or a spout are separate or separable units or one integrated unit.

The claims as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus comprising:
a main body comprising a fill opening;
collapsible sides;
wherein the main body and collapsible sides enclose a liquid holding reservoir;
wherein the liquid holding reservoir is in fluid communication with a spout.

2. The apparatus according to claim 1 wherein the main body is translucent and wherein the main body further has indicator lines to indicate the volume of liquid in the liquid holding reservoir.

3. The apparatus according to claim 1 wherein the spout is collapsible.

4. The apparatus according to claim 1 wherein the spout is foldable in a full circle around an axis through the center of the spout.

5. The apparatus according to claim 1 wherein the spout comprises accordion piping.

6. The apparatus according to claim 1 wherein the collapsible sides are made of a flexible material.

7. The apparatus according to claim 1 wherein the collapsible sides comprise thermoplastic elastomer material.

8. The apparatus according to claim wherein the collapsible sides comprise fold lines.

9. The apparatus according to claim 1 wherein the collapsible sides comprise handles.

10. The apparatus according to claim 1 wherein the spout comprises a sprinkler head housing.

11. The apparatus according to claim 1 wherein the sprinkler head housing is removable.

12. The apparatus according to claim wherein the sprinkler head housing fits within the fill opening without falling into the liquid holding reservoir.

13. The apparatus according to claim 1 wherein the main body further comprises ridge rings threaded with screw threads.

14. The apparatus according to claim 13 wherein the sides further comprise threaded coupling rings with screw threads that are complementary to the screw threads of the ridge rings on the main body and attach the sides to the main body when the coupling rings are screwed onto the ridge rings.

15. The apparatus according to claim 14 wherein gaskets are places between the main body and the sides where the coupling rings screw onto the ridge rings.

16. The apparatus according to claim 1 wherein the main body further comprises a gripping member.

17. The apparatus according to claim 16 wherein the gripping member comprises an upper end extending from the top of a front facing side to the bottom of a rear facing side.

18. A watering can comprising:
a rigid main body;
two flexible sides;
a spout;
wherein the two flexible sides are attached to the main body to form a liquid containing reservoir;
wherein the liquid containing reservoir is in fluid communication with the spout;
wherein the main body comprises colored translucent plastic and indicator lines to indicate the volume of water contained in a liquid containing reservoir;
wherein the main body further comprises two ridge rings with screw threading;
wherein the two flexible sides each comprise a gasket, a coupling ring, and a drum;
wherein the drums comprise thermoplastic elastomer;
wherein the drums further comprise handles;
wherein the gaskets are each a torus comprised of silicone;
wherein the coupling rings comprise rigid plastic with screw threading;
wherein the coupling rings are each fused to a drum to form two coupling drums;
wherein the coupling drums are each screwed onto the ridge rings to attach to the main body;
wherein the gaskets are disposed between the main body and the coupling drums; and
wherein the spout comprises accordion piping.
